(19) United States
(12) Patent Application Publication
(10) Pub. No.: US 2006/0259374 A1
(43) Pub. Date: Nov. 16, 2006

(54) System and method for managing product delivery platform

(75) Inventor: Mark Yu-Jen Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/095,086

(22) Filed: Mar. 30, 2005

(51) Int. Cl. G06Q 20/00; G07F 7/00; G06F 17/30

(52) U.S. Cl. 705/27; 705/23

(57) ABSTRACT

A system and a method for managing a product delivery platform are proposed. The system includes a to-be-repaired product database for storing data of products to be repaired; a data input module for inputting a quantity and a serial number of a product to be delivered; a data comparison module for automatically comparing the quantity of the product to be delivered with a maximum product delivery quantity stored in the to-be-repaired product database corresponding to the product, and analyzing composition of the serial number of the product to be delivered so as to determine whether the inputted quantity and serial number of the product to be delivered are correct; and a data access module for storing the serial number of the product to be delivered into the to-be-repaired product database so as to generate a product delivery list serving as a basis for delivering the product to be delivered.

### FIELD OF THE INVENTION

The present invention relates to systems and methods for managing product delivery platforms, and more particularly, to a system and method for managing product delivery, which can automatically determine whether quantities of products to be delivered and serial numbers of the products are correct.

### BACKGROUND OF THE INVENTION

Manufacturers often encounter situations in which they receive defective or faulted products that are returned by their distributors for repairing or replacement, such that the defective or faulted products can be restored and returned to their original distributors by the manufacturers. A conventional mode for delivering the repaired products from the manufacturers is usually performed by product delivery administrators manually inputting data such as quantities of products to be delivered and serial numbers of the products, and then delivering the products to their distributors according to the inputted data. This however does not provide a mechanism for examining whether the inputted data of products are correct. As a result, incorrect quantities or types of products may be delivered to the distributors usually due to mistakes of the product quantities or serial numbers being inputted via the product delivery administrators, thereby not only wasting a lot of time and money spent but also damaging the reputation of manufacturers.

Therefore, the problem to be solved here is to provide a system and method for managing product delivery, which can overcome the above drawbacks in the prior art.

### SUMMARY OF THE INVENTION

In light of the foregoing drawbacks in the prior art, a primary objective of the present invention is to provide a system and method for managing a product delivery platform, for allowing a product delivery administrator of a manufacturer to verify whether quantities of products to be delivered and serial numbers of the products being inputted thereby are correct, so as to increase accuracy of product delivery and prevent a waste of time and money spent and damage to reputation of the manufacturer due to delivering incorrect product quantities or types.

In accordance with the above and other objectives, the present invention proposes a system for managing a product delivery platform. The system comprises: a basic product maintenance database for storing product maintenance data including serial numbers of warranty certificates, serial numbers of manufacturing factories, and serial numbers of parts, etc.; a to-be-repaired product database for storing data of products to be repaired including serial numbers of repair lists, serial numbers of parts, serial numbers of the products to be repaired, serial numbers of products to be delivered, and serial numbers of the products in a distributor's database, etc.; a data input module for allowing a product delivery administrator to input product delivery data including a quantity and a serial number of a product to be delivered for use in a subsequent processing procedure of the product delivery data; a data comparison module for comparing the inputted quantity of the product to be delivered with a maximum product delivery quantity stored in the to-be-repaired product database corresponding to the product, and analyzing composition of the inputted serial number of the product to be delivered, so as to determine whether the inputted quantity and serial number of the product to be delivered are correct; and a data access module for storing the inputted serial number of the product to be delivered into the to-be-repaired product database so as to generate a product delivery list serving as a basis for delivering the product to be delivered.

The present invention also proposes a method for managing a product delivery platform in the use of the above system for managing a product delivery platform. The method comprises the steps of: (1) storing product maintenance data including serial numbers of warranty certificates, serial numbers of manufacturing factories, and serial numbers of parts, etc. into the basic product maintenance database, and storing data of products to be repaired, which are transmitted from a distributor, into the to-be-repaired product database, so as to allow the system at the time of product delivery to determine whether data of products to be delivered are consistent with the data of products to be repaired; (2) inputting a quantity of a product to be delivered, and automatically comparing the inputted quantity with a maximum product delivery quantity stored in the to-be-repaired product database corresponding to the product so as to verify whether the inputted quantity of the product to be delivered is correct; (3) inputting a serial number of the product to be delivered, and analyzing composition of the inputted serial number to compare components of the serial number with a corresponding serial number of warranty certificate, a corresponding serial number of manufacturing factory, and corresponding serial numbers of parts stored in the basic product maintenance database, so as to verify whether the inputted serial number is correct; and (4) finally storing the serial number of the product to be delivered into the to-be-repaired product database so as to generate a product delivery list serving as a basis for delivering the product to be delivered.

Therefore, by the system and method for managing a product delivery platform in the present invention, data of products to be repaired, which are transmitted from a distributor, are stored into the to-be-repaired product database, such that the system at the time of product delivery can determine whether data of products to be delivered are consistent with the data of products to be repaired. The data input module is actuated for inputting a quantity and a serial number of a product to be delivered. The quantity of the product to be delivered is compared with a maximum product delivery quantity stored in the to-be-repaired product database corresponding to the product, and the serial number of the product to be delivered is analyzed for its composition, so as to determine whether the quantity and serial number of the product to be delivered inputted via the data input module are correct. Finally, the serial number of the product to be delivered is stored into the to-be-repaired product database so as to generate a product delivery list serving as a basis for delivering the product to be delivered.

### BRIEF DESCRIPTION OF THE DRAWINGS

The present invention can be more fully understood by reading the following detailed description of the preferred embodiments, with reference made to the accompanying drawings, wherein:

FIG. 1 is a block schematic diagram showing a basic structure of a system for managing a product delivery platform according to the present invention;

FIG. 2 is a flowchart showing basic steps of a method for managing a product delivery platform according to the present invention;

FIG. 3 is a flowchart showing detailed procedures of determining a quantity of a product to be delivered in the method for managing a product delivery platform according to the present invention;

FIG. 4 is a flowchart showing detailed procedures of processing a serial number of the product to be delivered in the method for managing a product delivery platform according to the present invention;

FIG. 5 is a flowchart showing detailed procedures of storing product data in the method for managing a product delivery platform according to the present invention; and

FIG. 6 is a flowchart showing detailed procedures of verifying the serial number in the method for managing a product delivery platform according to the present invention.

### DETAILED DESCRIPTION OF THE PREFERRED EMBODIMENTS

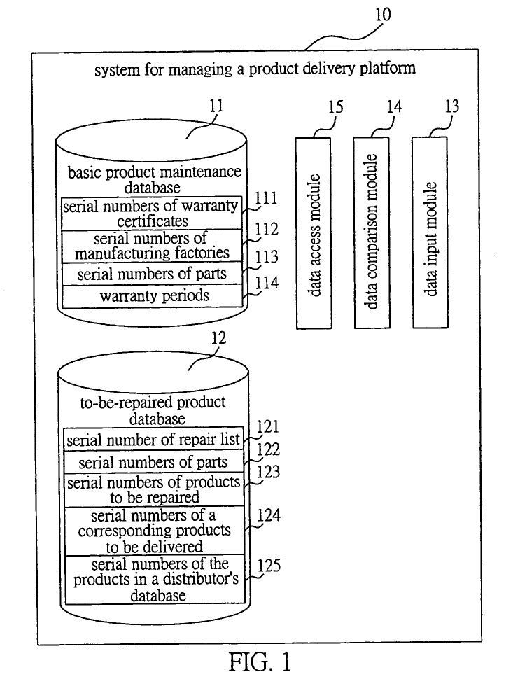

Preferred embodiments of a system and method for managing a product delivery platform proposed in the present invention are described in detail below with reference to FIGS. 1 to 6.

FIG. 1 illustrates a basic structure of the system for managing a product delivery platform in the present invention. As shown in FIG. 1, the system for managing a product delivery platform 10 in the present invention comprises a basic product maintenance database 11, a to-be-repaired product database 12, a data input module 13, a data comparison module 14, and a data access module 15.

The basic product maintenance database 11 is used to store product maintenance data, such as serial numbers of warranty certificates 111, serial numbers of manufacturing factories 112, serial numbers of parts 113, warranty periods 114 and so on, for allowing a manufacturer to obtain relevant information and a warranty term of each product for maintenance.

The to-be-repaired product database 12 is used to store data of products to be repaired, such as serial numbers of repair lists 121, serial numbers of parts 122, serial numbers of the product to be repaired 123, serial numbers of products to be delivered 124, and serial numbers of the products in a distributor's database 125. Storing the serial numbers of the products in the distributor's database 125 is because the manufacturer may alter relevant data of the products during product maintenance (for example, the manufacturer may replace a product not able to be repaired with a new product and deliver the new product to the original distributor). As a result, the distributor may need to accordingly alter relevant data of the products in its database, such that the distributor can store data of the products being repaired into its database to update the original product data according to the provided serial numbers of the products in the distributor's database 125.

The data input module 13 is used to allow a product delivery administrator to input product delivery data such as a quantity and a serial number of a product to be delivered so as to inform relevant personnel of the quantity and serial number of the product to be delivered to perform a processing procedure of the product delivery data.

The data comparison module 14 is used to compare the quantity of the product to be delivered inputted via the data input module 13 with a maximum product delivery quantity stored in the to-be-repaired product database 12 corresponding to the product so as to determine whether the inputted quantity of the product to be delivered is correct. Moreover, the data comparison module 14 is used to analyze composition of the serial number of the product to be delivered inputted via the data input module 13, and compare components of the serial number with a corresponding serial number of warranty certificate 111, a corresponding serial number of manufacturing factory 112 and corresponding serial numbers of parts 113 stored in the basic product maintenance database 11 so as to verify correctness of the inputted serial number of the product to be delivered.

The data access module 15 is used to store the serial number of the product to be delivered, which has been verified to be correct by the data comparison module 14, into a delivery product serial number column 124 of the to-be-repaired product database 12, so as to generate a product delivery list serving as a basis for delivering the product to be delivered.

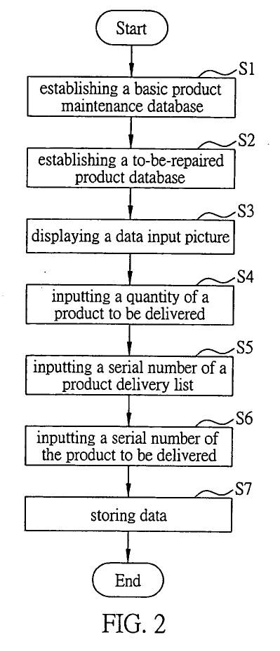

FIG. 2 illustrates a flowchart showing steps of the method for managing a product delivery platform in the present invention. As shown in FIG. 2, firstly, in step S1, a basic product maintenance database 11 is established for storing product maintenance data, such as serial numbers of warranty certificates 111, serial numbers of manufacturing factories 112, serial numbers of parts 113, warranty periods 114, and so on. Thereby, a manufacture can obtain relevant information and a warranty term of a product to be repaired. Since a serial number of product comprises a corresponding serial number of warranty certificate, a corresponding serial number of manufacturing factory, corresponding serial numbers of parts, etc., such that correctness of a serial number of the product to be repaired can be verified according to the serial numbers of warranty certificates 111, the serial numbers of manufacturing factories 112 and the serial numbers of parts 113 stored in the basic product maintenance database 11. Then, the method proceeds to step S2.

In step S2, data of the product to be repaired, which are transmitted from a corresponding distributor, are stored into a to-be-repaired product database 12, so as to allow a data comparison module 14 at the time of product delivery to determine whether product delivery data are consistent with the data of product to be repaired. The to-be-repaired product database 12 stores data of the product to be repaired, such as a serial number of repair list 121, serial numbers of parts 122, a serial number of the product to be repaired 123, a serial number of a corresponding product to be delivered 124, a serial number of the product in a distributor's database 125, and so on. Then, the method proceeds to step S3.

In step S3, the serial number of repair list 121 and the serial numbers of parts 122 are inputted via a data input module 13 so as to display a data input picture corresponding to the product to be repaired, and read a maximum product delivery quantity (i.e. a quantity in stock) from the to-be-repaired product database 12 corresponding to the product to display the maximum product delivery quantity on the data input picture. Then, the method proceeds to step S4.

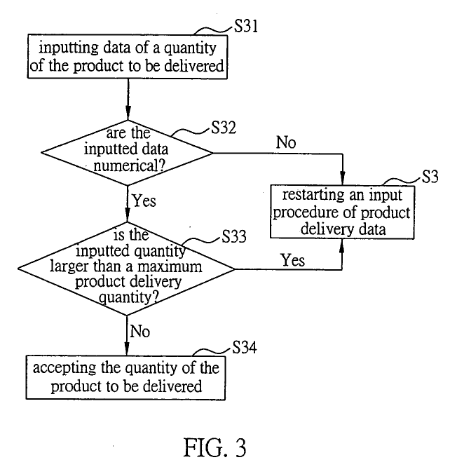

In step S4, a quantity of the corresponding product to be delivered is inputted via the data input module 13, and the data comparison module 14 determines whether the quantity of the product to be delivered is correct, so as to inform relevant personnel of the quantity of the product to be delivered. Detailed procedures of determining whether the quantity of the product to be delivered is correct are disclosed in FIG. 3 and described later. Then, the method proceeds to step S5.

In step S5, a serial number of a corresponding product delivery list is inputted via the data input module 13, so as to allow delivery personnel to verify the product delivery data, and allow relevant personnel to search and trace the product delivery data according to the serial number of the product delivery list. Then, the method proceeds to step S6.

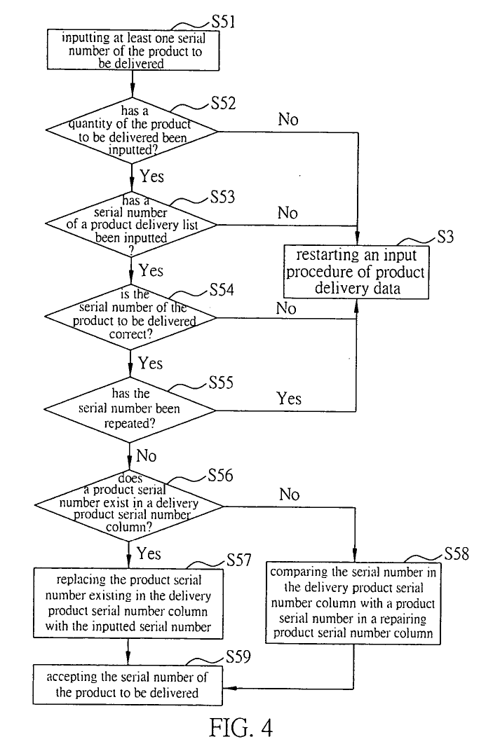

In step S6, a serial number of the corresponding product to be delivered is inputted via the data input module 13, allowing the data comparison module 14 to determine whether the serial number is correct. The serial number of the product to be delivered, if being determined to be correct, is placed in a delivery product serial number column 124 of the to-be-repaired product database 12. Detailed procedures of processing the serial number are disclosed in FIG. 4 and described later. Then, the method proceeds to step S7.

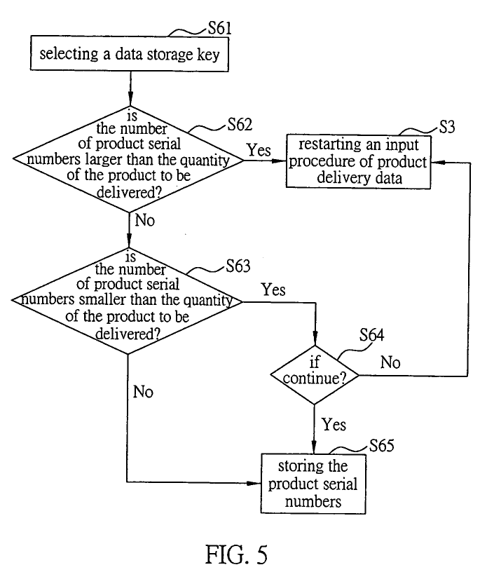

In step S7, a data access module 15 stores the foregoing serial number of the product to be delivered into the delivery product serial number column 124 of the to-be-repaired product database 12, such that relevant personnel can search and trace the product delivery data, and the corresponding product delivery list can be generated to serve as a basis for delivering the product to be delivered. Detailed procedures of storing product data are disclosed in FIG. 5 and described later.

FIG. 3 illustrates detailed procedures of determining a quantity of the product to be delivered in the method for managing a product delivery platform according to the present invention. As shown in FIG. 3, firstly, in step S3 1, product delivery data including a quantity of the product to be delivered are inputted via the data input module 13. Then, it proceeds to step S32.

In step S32, the data comparison module 14 determines whether the product delivery data inputted via the data input module 13 are numeric. If no, a message window is displayed to inform a product delivery administrator that the inputted product delivery data are erroneous, then returning to step S3 to restart an input procedure of product delivery data; or, if the inputted product delivery data are numeric, then it proceeds to step S33.

In step S33, according to the serial number of repair list 121 and the serial numbers of parts 122, the data access module 15 searches a maximum product delivery quantity (i.e. a quantity in stock) from the to-be-repaired product database 12 corresponding to the product to be delivered. Subsequently, the data comparison module 14 determines whether the inputted quantity of the product to be delivered is larger than the maximum product delivery quantity. If yes, a message window is displayed to inform the product delivery administrator that the quantity of the product to be delivered inputted thereby is larger than the maximum product delivery quantity, then returning to step S3 to restart the input procedure of product delivery data; or, if the quantity of the product to be delivered is not larger than the maximum product delivery quantity, the quantity of the product to be delivered is considered correct, then proceeding to step S34.

In step S34, the system for managing a delivery platform 10 accepts the quantity of the product to be delivered inputted via the data input module 13, and performs a quantity comparison when the data access module 15 stores product data.

FIG. 4 illustrates detailed procedures of processing a serial number of the product to be delivered in the method for managing a product delivery platform according to the present invention. As shown in FIG. 4, firstly, in step S51, at least one serial number of the product to be delivered is inputted via the data input module 13. Then, it proceeds to step S52.

In step S52, the data comparison module 14 determines whether a quantity of the product to be delivered has been inputted. If no, a message window is displayed to inform the product delivery administrator that the quantity of the product to be delivered should be inputted in advance, then returning to step S3 to restart the input procedure of product delivery data; or, if the quantity of the product to be delivered has been inputted, then it proceeds to step S53.

In step S53, the data comparison module 14 determines whether a serial number of a corresponding product delivery list has been inputted. If no, a message window is displayed to inform the product delivery administrator that the serial number of the corresponding product delivery list should be inputted in advance, then returning to step S3 to restart the input procedure of product delivery data; or, if the serial number of the corresponding product delivery list has been inputted, then it proceeds to step S54.

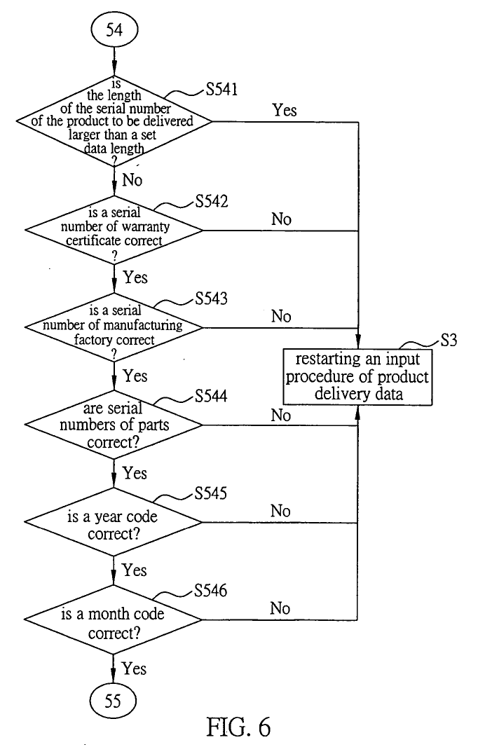

In step S54, the data comparison module 14 determines whether the inputted serial number of the product to be delivered is correct. If no, then it returns to step S3 to restart the input procedure of product delivery data; or, if the inputted serial number is correct, then it proceeds to step S55. Detailed procedures of determining whether the serial number is correct are disclosed in FIG. 6 and described later.

In step S55, the data comparison module 14 determines whether the inputted serial number of the product to be delivered has been repeated. If yes, a message window is displayed to inform the product delivery administrator that the repeated serial number is inputted, then returning to step S3 to restart the input procedure of product delivery data; or, if the inputted serial number has not been repeated, then it proceeds to step S56.

In step S56, the data comparison module 14 verifies whether there has been a product serial number in the delivery product serial number column 124 of the to-be-repaired product database 12. If yes, then it proceeds to step S57; or, if there is no product serial number in the delivery product serial number column 124, then it proceeds to step S58.

In step S57, the product serial number in the delivery product serial number column 124 of the to-be-repaired product database 12 is replaced by the serial number of the product to be delivered inputted via the data input module 13, and is moved to a delivery product serial number column 124 of another record having the same serial number of repair list 121 and serial numbers of parts 122. Then, it proceeds to step S59.

In step S58, the serial number of the product to be delivered inputted via the data input module 13 is placed in the delivery product serial number column 124 of the to-be-repaired product database 12, to automatically determine whether the serial number in the delivery product serial number column 124 is consistent with a product serial number in a repairing product serial number column 123. If yes, the product data inputted by the product delivery administrator are placed in a delivery product serial number column 124 of the record; or, if no product serial number in the repairing product serial number column 123 having the same serial number of repair list 121 and serial numbers of parts 122 is consistent with the serial number of the product to be delivered inputted via the data input module 13, the inputted serial number is randomly placed in a delivery product serial number column 124 of any record having the same serial number of repair list 121 and serial numbers of parts 122. Then, it proceeds to step S59.

In step S59, the system for managing delivery platform 10 accepts the serial number inputted by the product delivery administrator, and waits for the data access module 15 to perform data storage to store the serial number in the delivery product serial number column 124 into the to-be-repaired product database 12.

FIG. 5 illustrates detailed procedures of storing product data in the method for managing a product delivery platform according to the present invention. As shown in FIG. 5, firstly, in step S61, a data storage key is selected via the data input module 13 to perform data storage. Then, it proceeds to step S62.

In step S62, the number of product serial numbers inputted in step S51 is calculated, allowing the data comparison module 14 to compare the number of product serial numbers with the quantity of the product to be delivered inputted in step S31. If the number of product serial numbers is larger than the quantity of the product to be delivered, a message window is displayed to inform the product delivery administrator that the inputted number of product serial numbers is larger than the quantity of the product to be delivered, then returning to step S3 to restart the input procedure of product delivery data; or, if the number of product serial numbers is not larger than the quantity of the product to be delivered, then it proceeds to step S63.

In step S63, the data comparison module 14 compares the number of product serial numbers with the quantity of the product to be delivered. If the number of product serial numbers is smaller than the quantity of the product to be delivered, a message window is displayed to inform the product delivery administrator that the inputted number of product serial numbers is smaller than the quantity of the product to be delivered and also allow the product delivery administrator to select a confirmation key to store the product serial numbers into the to-be-repaired product database 12, then proceeding to step S64; or, if the number of product serial numbers is not smaller than the quantity of the product to be delivered, then it proceeds to step S65.

In step S64, it determines whether the confirmation key is selected via the data input module 13. If yes, then it proceeds to step S65; or, if a cancellation key is selected, then it returns to step S3 to restart the input procedure of product delivery data.

In step S65, the data access module 15 stores the product serial numbers in the delivery product serial number column 124 into the to-be-repaired product database 12 so as generate the product delivery list serving as a basis for delivering the product to be delivered.

FIG. 6 illustrates detailed procedures of verifying the serial number of the product to be delivered in the method for managing a product delivery platform according to the present invention. As shown in FIG. 6, firstly, in step S541, the data comparison module 14 determines whether the length of the serial number of the product to be delivered inputted via the data input module 13 is larger than a data length set by the delivery product serial number column 124 in the to-be-repaired product database 12. If yes, a message window is displayed to inform the product delivery administrator that the length of the inputted serial number is incorrect, then returning to step S3 to restart the input procedure of product delivery data; or, if the length of the inputted serial number is not larger than the set data length, then it proceeds to step S542.

In step S542, the data comparison module 14 analyzes composition of the inputted serial number of the product to be delivered, and determines whether a serial number of warranty certificate contained in the serial number of the product to be delivered is consistent with a corresponding serial number of warranty certificate 111 stored in the basic product maintenance database 11. If no, a message window is displayed to inform the product delivery administrator that the inputted serial number contains an incorrect serial number of warranty certificate, then returning to step S3 to restart the input procedure of product delivery data; or, if the serial number of warranty certificate contained in the serial number of the product to be delivered matches the corresponding serial number of warranty certificate 111, then it proceeds to step S543.

In step S543, the data comparison module 14 determines whether a serial number of manufacturing factory contained in the inputted serial number of the product to be delivered is consistent with a corresponding serial number of manufacturing factory 112 stored in the basic product maintenance database 11. If no, a message window is displayed to inform the product delivery administrator that the inputted serial number contains an incorrect serial number of manufacturing factory, then returning to step S3 to restart the input procedure of product delivery data; or, if the serial number of manufacturing factory contained in the serial number of the product to be delivered matches the corresponding serial number of manufacturing factory 112, then it proceeds to step S544.

In step S544, the data comparison module 14 determines whether serial numbers of parts contained in the inputted serial number of the product to be delivered are consistent with corresponding serial numbers of parts 113 stored in the basic product maintenance database 11. If no, a message window is displayed to inform the product delivery administrator that the inputted serial number contains incorrect serial numbers of parts, then returning to step S3 to restart the input procedure of product delivery data; or, if the serial numbers of parts contained in the serial number of the product to be delivered match the corresponding serial numbers of parts 113, then it proceeds to step S545.

In step S545, the data comparison module 14 determines whether a year code contained in the inputted serial number of the product to be delivered is correct. If no, a message window is displayed to inform the product delivery administrator that the inputted serial number contains an incorrect year code, then returning to step S3 to restart the input procedure of product delivery data; or, if the year code is correct, then it proceeds to step S546.

In step S546, the data comparison module 14 determines whether a month code contained in the inputted serial number of the product to be delivered is correct. If no, a message window is displayed to inform the product delivery administrator that the inputted serial number contains an incorrect month code, then returning to step S3 to restart the input procedure of product delivery data; or, if the month code is correct, then it proceeds to step S55.

Therefore, by the system and method for managing a product delivery platform in the present invention, data such as serial numbers of warranty certificates, serial numbers of manufacturing factories, serial numbers of parts and so on are stored into the basic product maintenance database, and data of products to be repaired, which are transmitted from a distributor, are stored into the to-be-repaired product database, such that the system at the time of product delivery can determine whether data of products to be delivered are consistent with the data of products to be repaired. The data input module is actuated for inputting a quantity and a serial number of a product to be delivered. The quantity of the product to be delivered is compared with a maximum product delivery quantity stored in the to-be-repaired product database corresponding to the product, and the serial number of the product to be delivered is analyzed for its composition, so as to determine whether the quantity and serial number of the product to be delivered inputted via the data input module are correct. Finally, the serial number of the product to be delivered is stored into the to-be-repaired product database so as to generate a product delivery list serving as a basis for delivering the product to be delivered.

The invention has been described using exemplary preferred embodiments. However, it is to be understood that the scope of the present invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system for managing a product delivery platform, comprising:
a basic product maintenance database for storing product maintenance data;
a to-be-repaired product database for storing data of products to be repaired;
a data input module for inputting a quantity and a serial number of a product to be delivered; and
a data comparison module for comparing the quantity and serial number of the product to be delivered inputted via the data input module with the product maintenance data stored in the basic product maintenance database and the data of products to be repaired stored in the to-be-repaired product database, so as to verify correctness of the inputted quantity and serial number of the product to be delivered.

2. The system of claim 1, further comprising:
a data access module for storing the serial number of the product to be delivered, which has been verified to be correct by the data comparison module, into the to-be-repaired product database so as to generate a product delivery list serving as a basis for delivering the product to be delivered.

3. A method for managing a product delivery platform, comprising the steps of:
storing product maintenance data and data of products to be repaired;
setting a quantity of a product to be delivered, and comparing the quantity of the product to be delivered with the data of products to be repaired so as to verify correctness of the quantity of the product to be delivered; and
reading a serial number of the product to be delivered, and comparing the serial number with the product maintenance data so as to verify correctness of the serial number.

4. The method of claim 3, wherein the product maintenance data comprise serial numbers of warranty certificates, serial number of manufacturing factories, or serial numbers of parts.

5. The method of claim 3, wherein the data of products to be repaired comprise serial numbers of repair lists, serial numbers of parts, serial number of the products to be repaired, or serial numbers of products to be delivered.

6. The method of claim 3, wherein the quantity of the product to be delivered is compared with a corresponding maximum product delivery quantity to verify the correctness of the quantity of the product to be delivered.

7. The method of claim 6, wherein the maximum product delivery quantity refers to a product quantity with a serial number of repair list and serial number of parts thereof being identical to those of the product to be delivered.

8. The method of claim 3, wherein the serial number of the product to be delivered comprises a serial number of warranty certificate, a serial number of manufacturing factory, or serial numbers of parts.

9. The method of claim 3, further comprising storing the serial number of the product to be delivered into a delivery product serial number column.

10. The method of claim 3, further comprising generating a product delivery list serving as a basis for delivering the product to be delivered.
